(19) United States
(12) Patent Application Publication
(10) Pub. No.: US 2006/0021815 A1
(43) Pub. Date: Feb. 2, 2006

(54) Occupant protecting system

(75) Inventor: Koji Ohtaka, Anjo-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/194,653

(22) Filed: Aug. 2, 2005

(30) Foreign Application Priority Data
Aug. 2, 2004 (JP) 2004-225817

(51) Int. Cl. B60K 28/10

(52) U.S. Cl. 180/274

(57) ABSTRACT

An occupant protecting system includes elongated pressure sensors. The pressure sensors is extended at least partially in at least one of a longitudinal direction of a side portion of a vehicle and a transverse direction of a front portion of the vehicle. The pressure sensors are able to detect a pressure substantially throughout the whole in the vehicular longitudinal direction which pressure is exerted on the vehicle from the exterior of the vehicle. An occupant protecting ECU drives occupant protecting means upon receipt of a detected signal from the pressure sensors.

### CROSS-REFERENCE TO RELATED APPLICATION

This application is based on Japanese Patent Application No. 2004-225817 filed on Aug. 2, 2004, the disclosure of which is incorporated herein by reference.

### FIELD OF THE INVENTION

The present invention relates to an occupant protecting system as a passive safety system for protecting occupants of a vehicle from a shock exerted on the vehicle.

### BACKGROUND OF THE INVENTION

In conventional airbag systems there are used G-sensors (acceleration sensors) for detecting a shock as shown in JP-2000-233708A. FIG. 14 is a perspective top view of a vehicle in which a conventional airbag system is installed. An airbag system 100 includes a left side-sill G-sensor 101L, a left B-pillar G-sensor 102L, a left C-pillar G-sensor 103L, a right side-sill G-sensor 101R, a right B-pillar G-sensor 102R, a right C-pillar G-sensor 103R and an airbag ECU (Electric Control Unit) 104.

For example, in the event of collision of another vehicle against a right front door, the right side-sill G-sensor 101R detects an acceleration waveform. The detected acceleration waveform is transmitted to the airbag ECU 104, in which the acceleration waveform is converted from analog to digital. Then, a moving average value is calculated from the digital-converted acceleration waveform. A crash discriminating threshold value is stored beforehand in the airbag ECU 104. The moving average value is compared with the crash discriminating threshold value. The airbag ECU 104 itself is also provided with a floor G-sensor (not shown). A moving average value of an acceleration waveform detected by the floor G-sensor is also compared with the crash discriminating threshold value.

When the moving average value of an acceleration waveform of the right side-sill G-sensor 101R and that of the floor G-sensor exceed the crash discriminating threshold value, the airbag ECU 104 drives a right front seat side-airbag (not shown) which is accommodated within a backrest portion of a right front seat. As a result, the right front seat side-airbag inflates within into the vehicle compartment. In this way the airbag system 100 protects the occupant sitting on the right front seat.

However, the G-sensors referred to above (left side-sill G-sensor 101L, left B-pillar G-sensor 102L, left C-pillar G-sensor 103L, right side-sill G-sensor 101R, right B-pillar G-sensor 102R, right C-pillar G-sensor 103R) are dotted in a vehicle body 105. The G-sensors cannot detect an acceleration unless they themselves receive the acceleration. Therefore, the shock detecting accuracy of a G-sensor is deteriorated at a certain shocked position. More particularly, the detection accuracy of a G-sensor is deteriorated when a shock transfer path from a shocked position to the G-sensor is long or when the member which constitutes the shock transfer path is easily deformed to absorb a shock.

Forming the member as a constituent of the shock transfer path with use of a rigid material difficult to be deformed by a shock may be effective in suppressing the lowering of the detection accuracy. In this case, however, the cost of installing the airbag system 100 becomes high.

The lowering of the detection accuracy may be suppressed by limiting the position of each G-sensor to only the position able to ensure a shock transfer path superior in shock transfer characteristic. In this case, however, the degree of freedom of the G-sensor installing place becomes lower inevitably.

Further, in the above airbag system 100, the response time until start-up of the occupant protecting means (e.g., the right front seat side-airbag) after the receipt of a shock becomes longer. That is, for determining whether the occupant protecting means is to be operated or not, it is necessary to calculate a moving average value from the acceleration waveform detected by the G-sensor. Additionally, as described above, when a shock is applied to a position where a G-sensor is not disposed, the shock is transferred to a G-sensor through the shock transfer path. Consequently, the response time until start-up of the occupant protecting means after the receipt of a shock becomes longer.

### SUMMARY OF THE INVENTION

The occupant protecting system of the present invention has been completed in view of the above-mentioned problems. Accordingly, it is an object of the present invention to provide an occupant protecting system able to suppress a lowering of the shock detection accuracy, low in the installation cost, high in the degree of freedom of the sensor installing place and short in the response time until start-up of occupant protecting means after the receipt of a shock.

According to the present invention, for solving the above-mentioned problems, there is provided an occupant protecting system comprising an elongated pressure sensor, at least a part of the pressure sensor being extended in at least one of a longitudinal direction of a vehicle in a side portion of the vehicle and a transverse direction of the vehicle in a front portion of the vehicle, the pressure sensor being able to detect a pressure substantially throughout the whole in a longitudinal direction of the vehicle which pressure is exerted on the vehicle from the exterior of the vehicle, and an occupant protecting ECU which drives occupant protecting means upon receipt of a detected signal from the pressure sensor.

That is, in the occupant protecting system of the present invention, a shock induced by collision for example is detected not by a G-sensor but by a pressure sensor. The pressure sensor, which is an elongated sensor, can detect a pressure substantially throughout the whole in the longitudinal direction of a vehicle which pressure is exerted on the vehicle from the exterior of the vehicle. Further, at least a part of the pressure sensor extends in at least one of a longitudinal direction of a side portion of the vehicle and a transverse direction of a front portion of the vehicle.

Thus, according to the occupant protecting system of the present invention, for example when the pressure sensor is disposed in a side portion of the vehicle, a pressure (i.e., shock) can be detected over a predetermined section in the vehicular longitudinal direction. When the pressure sensor is disposed in the vehicular front portion, a pressure can be detected over a predetermined section in the vehicular transverse direction.

In the occupant protecting system of the present invention there is used, not G-sensors capable of being arranged only “dotwise,” but a pressure sensor capable of being disposed “linearly (or band-like).” Therefore, the length of a shock transfer path from a shocked position up to the pressure sensor can be made short or zero. Consequently, it is possible to suppress a lowering of the shock detecting accuracy.

Besides, since the shock transfer path is short, the shock absorbability of the member which constitutes the shock transfer path need not be taken into account. Consequently, it is possible to reduce the installation cost of the occupant protecting system. Moreover, the degree of freedom of the sensor installing place becomes high.

Further, the use of the pressure sensor eliminates the need of the foregoing complicated calculation in the occupant protecting ECU. Additionally, as noted above, the shock transfer path from a shocked position to the pressure sensor becomes short, so that it is possible to shorten the response time until start-up of the occupant protecting means after the receipt of a shock.

Preferably, the pressure sensor is disposed on a side door of the vehicle. In the event of a vehicular side crash (hereinafter referred to as “side crash”), it is preferable that the response time until start-up of the occupant protecting means after the receipt of a shock in a vehicular side portion be as short as possible. The reason is that the distance from the shocked position to the occupant is relatively short and so is the distance from the occupant to the occupant protecting means (e.g., a side-airbag or a curtain-airbag).

The trend of request for shortening the response time in the event of a side crash is observed also as the trend of laws and regulations. For example, in the U.S., as part of an upgrade study of FMVSS214 which is a crash test applicable at present, an oblique pole side crash test is now under study. This test simulates a crash of a vehicle against a tree or an electric pole. In this test, an injury value against a dummy in the event of a crash of a vehicle sideways against a column having a diameter of 254 mm is regulated. Conditions for the test includes 1) crash angle: 75° relative to the vehicle advancing direction, 2) crash speed: 32 km/h, 3) dummies used: both male dummy (ES-2re ATD) and female dummy (SID-lIsFRG 5th percentile), 4) dummy position: front outer sitting positions, and 5) crash reference regions: chest, loin, head.

In view of this point the pressure sensor of this construction is disposed near each of right and left outer edges of the vehicle, whereby a shock from a side portion of the vehicle can be detected rapidly. Consequently, the response time until start-up of the occupant protecting means after the receipt of a shock in a side portion of the vehicle can be further shortened.

### BRIEF DESCRIPTION OF THE DRAWINGS

FIG. 1 is a perspective top view of a vehicle in which an airbag system according to a first embodiment of the present invention is installed;

FIG. 2 is a perspective top view of the vehicle, showing a layout of airbags;

FIG. 3 is a perspective view of a right front seat and the vicinity thereof in the vehicle;

FIG. 4 is a right side view of the vehicle;

FIG. 5 is a sectional view taken on line V-V in FIG. 4;

FIG. 6 is an enlarged view of the interior of a circle VI in FIG. 5;

FIG. 7 is a block diagram of the airbag system;

FIG. 8 is a circuit diagram of a right front seat touch-sensor in the airbag system;

FIG. 9 is a sectional view in a direction perpendicular to the axis of the right front seat touch-sensor in the event of a side crash of the airbag system;

FIG. 10 is a perspective view of a right front seat and the vicinity thereof in a vehicle in which an airbag system according to a second embodiment of the present invention is installed;

FIG. 11 is a sectional view of a lower edge of a right front side door and the vicinity thereof in the vehicle;

FIG. 12 is a perspective view of a right front seat and the vicinity thereof in a vehicle in which an airbag system according to a third embodiment of the present invention is installed;

FIG. 13 is a sectional view of a lower edge of a right front side door and the vicinity thereof in the vehicle;

FIG. 14 is a schematic view of an optical fiber sensor; and

FIG. 15 is a perspective top view of a vehicle in which a conventional airbag system is installed.

### DETAILED DESCRIPTION OF PREFERRED EMBODIMENTS

Airbag systems for a side shock as occupant protecting systems according to embodiments of the present invention will be described hereinunder with reference to the accompanying drawings.

### First Embodiment

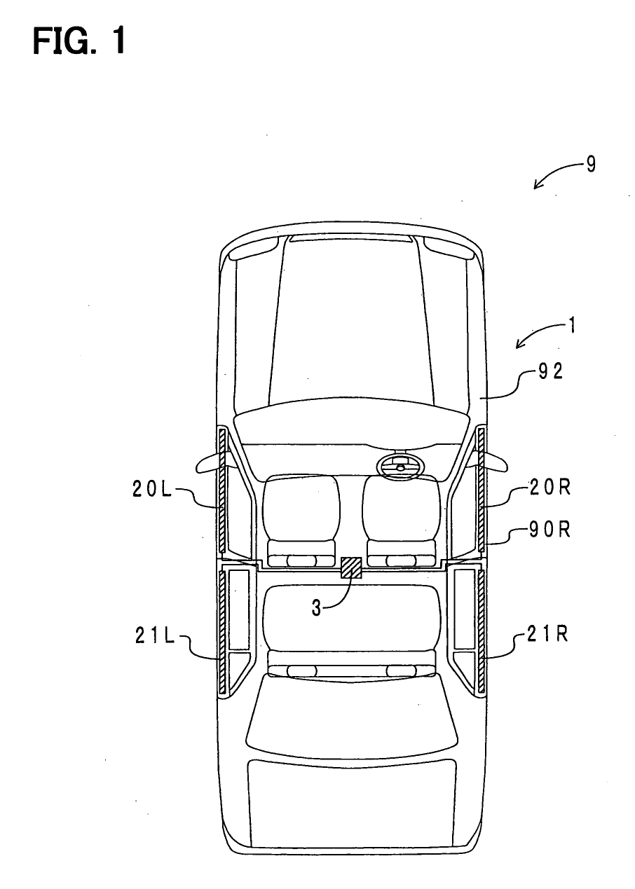

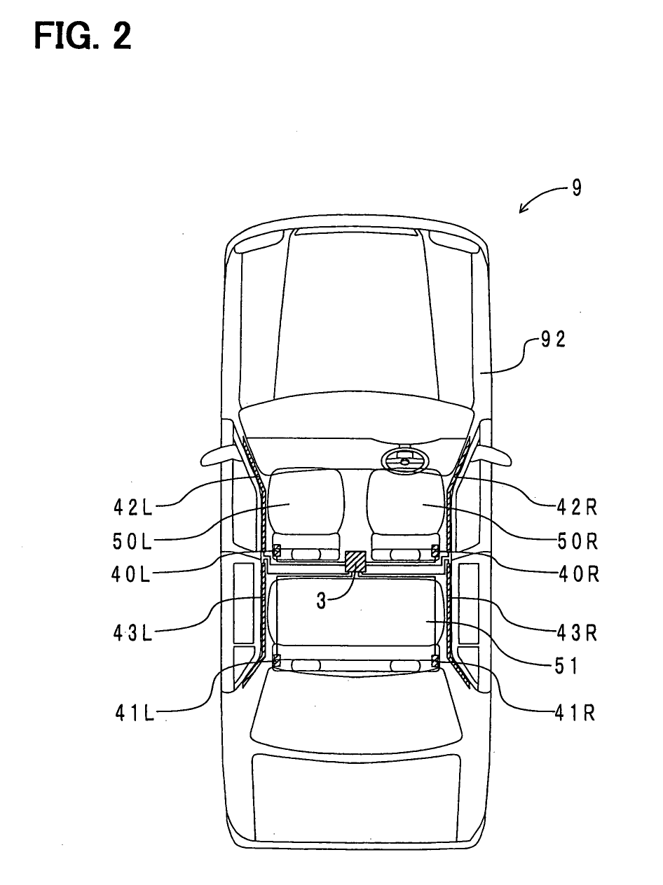

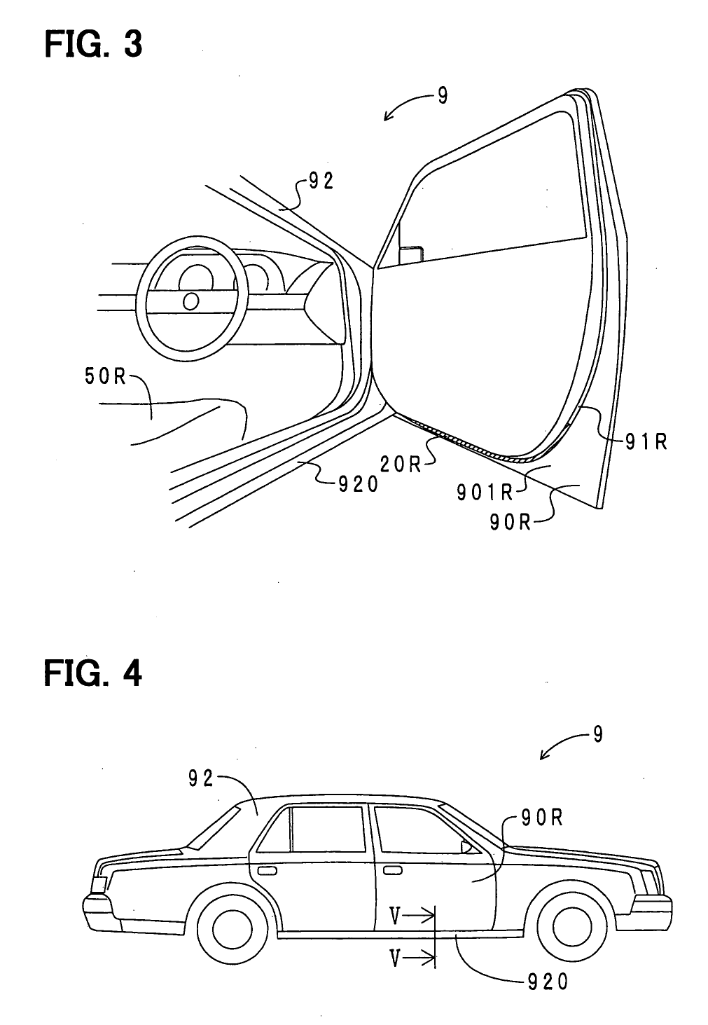

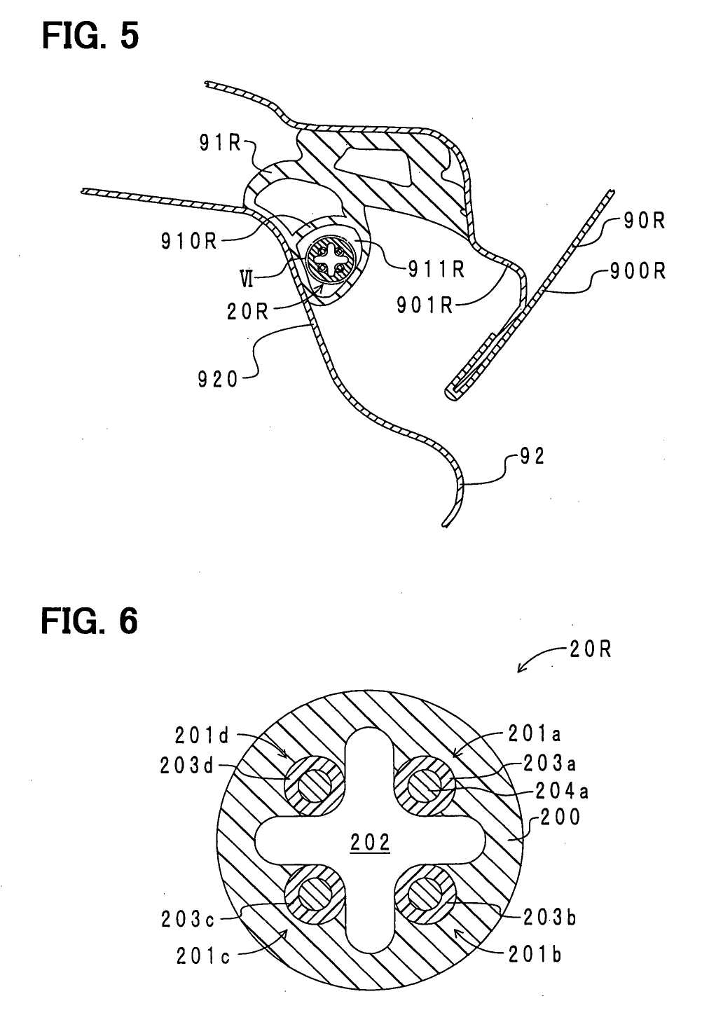

A description will first be given about a layout of an airbag system according to a first embodiment of the present invention. FIG. 1 is a perspective top view of a vehicle in which the airbag system of this embodiment is installed. FIG. 2 is a perspective top view of the vehicle, showing a layout of airbags. FIG. 3 is a perspective view of a right front seat and the vicinity thereof in the vehicle. FIG. 4 is a right side view of the vehicle. FIG. 5 is a sectional view taken on line V-V in FIG. 4. In FIGS. 1 to 3, touch-sensors, airbag ECU and airbags are hatched for the sake of convenience.

A right front seat side-airbag 40R is embedded in the right side (outer side in the vehicular transverse direction) of a backrest of a right front seat 50R. A right rear seat side-airbag 41R is embedded in the right side of a rear seat 51. A right front seat curtain-airbag 42R is embedded from a right edge of a front portion of a ceiling in a vehicle compartment up to a pillar A. A right rear seat curtain-airbag 43R is embedded from a right edge of a rear portion of the ceiling in the vehicle compartment up to a pillar C.

Symmetrically with the layout of the right side-airbags, a left front seat side-airbag 40L is embedded in the left side (outer side in the vehicle transverse direction) of backrest portion of a left front seat 50L. A left rear seat side-airbag 41L is embedded in the left side of the rear seat 51. A left front seat curtain-airbag 42L is embedded from a left edge of the ceiling front portion in the vehicle compartment up to the pillar A. A left rear seat curtain-airbag 43L is embedded from a left edge of the ceiling rear portion in the vehicle compartment up to the pillar C.

An airbag ECU 3 is embedded under a nearly central floor portion of the vehicle 9. The airbag ECU 3 is included in an occupant protecting ECU according to the present invention. The airbag ECU 3 and the right front seat side-airbag 40R, the right rear seat side-airbag 41R, the right front seat curtain-airbag 42R, the right rear seat curtain-airbag 43R, the left front seat side-airbag 40L, the left rear seat side-airbag 41L, the left front seat curtain-airbag 42L, the left rear seat curtain-airbag 43L, are connected together through a harness.

The airbag system of this embodiment, indicated at 1, includes a right front seat touch-sensor 20R, a right rear seat touch-sensor 21R, a left front seat touch-sensor 20L, a left rear seat touch-sensor 21L, and the airbag ECU 3.

The right front seat touch-sensor 20R has a string-like appearance and it is accommodated within an opening weather strip 91R. More specifically, the right front seat touch-sensor 20R is accommodated within the opening weather strip 91R over a region including the overall length of a lower edge of a right front seat door 90R and a part of a rear edge thereof. The right front seat door 90R includes an outer panel 900R located outside the vehicle compartment and an inner panel 901R located inside the vehicle compartment. The opening weather strip 91R is disposed in a generally rectangular frame shape on a surface of the inner panel 901R. The opening weather strip 91R is made of rubber and is tube-like. When the right front seat door 90R is closed, the opening weather strip 91R is put in elastic contact with a side-sill 920 of a vehicle body 92. Sealing between the right front seat door 90R and the side-sill 920 is ensured. An accommodating chamber 911R is defined by a partition wall 910R in the interior of the opening weather strip 91R. The right front seat touch-sensor 20R is accommodated within the accommodating chamber 911R. The right front seat touch-sensor 20R and the airbag ECU 3 are connected with each other through a harness.

The right rear seat touch-sensor 21R, the left front seat touch-sensor 20L and the left rear seat touch-sensor 21L are also arranged in the same manner as the right front seat touch-sensor 20R and therefore explanations thereof are here omitted.

Next, a description will be given about the construction of touch-sensors used in the airbag system of this embodiment. FIG. 6 is an enlarged view of the interior of a circle VI in FIG. 1. As shown in FIG. 6, the right front seat touch-sensor 20R includes a skin portion 200 and electrode wires 201a to 201d. The skin portion 200 is made of a flexible insulating resin and has an elongated tube-like appearance. A crossed hole 202 is formed in the interior of the skin layer 200.

The electrode wire 201a includes an outer layer 203a and an inner layer 204a. The inner layer 204a is a copper wire of a circular section. The outer layer 203a is made of an electrically conductive resin and covers the outer periphery of the inner layer 204a. The constructions of the electrode wires 201b to 201d are the same as the construction of the electrode wire 201a and therefore explanations thereof are here omitted.

The four electrode wires 201a to 201d are arranged spacedly at intervals of 90° near the crossing part of the crossed hole 202. The four electrode wires 201a to 201d are arranged spirally in the longitudinal direction. The outer layers 203a to 203d of the electrode wires 201a to 201d are partially exposed to the interior of the crossed hole 202.

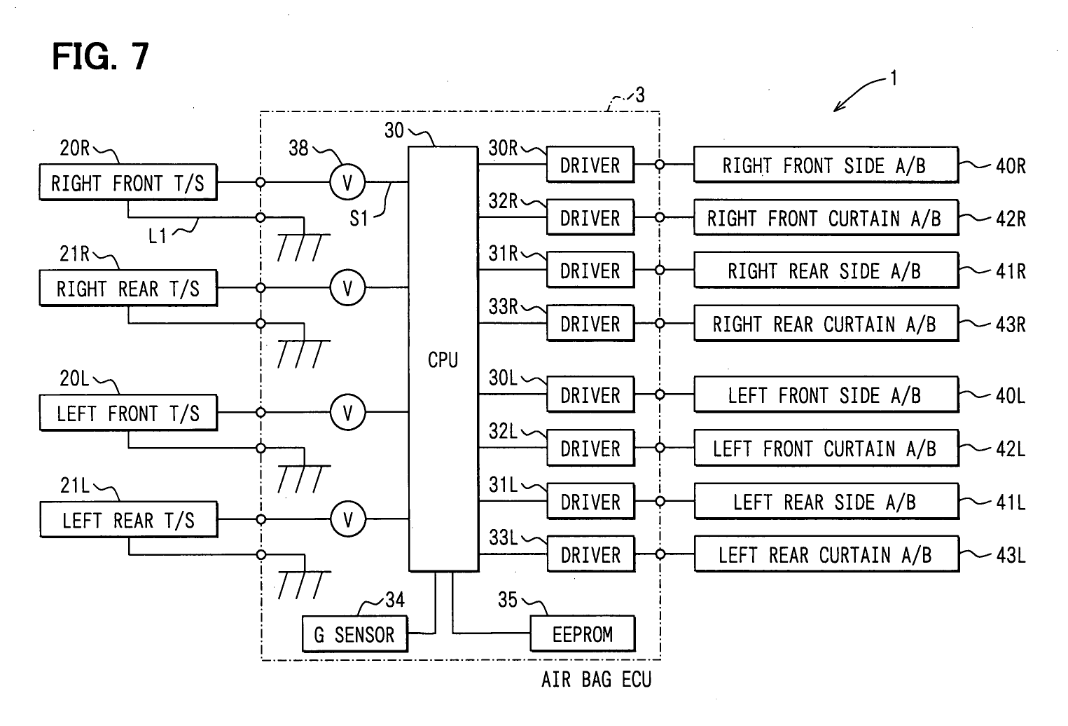

The following description is now provided about a circuit configuration of the airbag system of this embodiment. FIG. 7 is a block diagram of the airbag system of this embodiment. As shown in the same figure, the airbag ECU 3 includes as main components a CPU (central processing unit) 30, drive circuits 30R to 33R and 30L to 33L, a G-sensor 34, and an EEPROM 35.

The CPU 30 is connected to a right front seat touch-sensor 20R, a right rear seat touch-sensor 21R, a left front seat touch-sensor 20L and a left rear seat touch-sensor 21L. The CUP 30 is driven by a 5V power supply (not shown) which converts a battery voltage (12V) into 5V. The CPU 30 includes RAM and ROM (neither shown). Occupant information and an acceleration signal provided from the G-sensor 34 are temporarily stored in the RAM. A program (not shown) for the discrimination of a crash is stored beforehand in the ROM.

The G-sensor 34 is an electric acceleration sensor capable of detecting a vehicle acceleration (deceleration) and it is connected to the CPU 30. The EEPROM 35 is an electrically rewritable non-volatile memory. In the airbag ECU 3 is stored, for example, a self-diagnosis result thereof.

The drive circuit 30R is connected to a right front seat side-airbag 40R, the drive circuit 32R is connected to a right front seat curtain-airbag 42R, the drive circuit 31R is connected to a right rear seat side-airbag 41R, the drive circuit 33R is connected to a right rear seat curtain-airbag 43R, the drive circuit 30L is connected to a left front seat side-airbag 40L, the drive circuit 32L is connected to a left front seat curtain-airbag 42L, the drive circuit 31L is connected to a left rear seat side-airbag 41L, and the drive circuit 33L is connected to a left rear seat curtain-airbag 43L.

The drive circuit 30R includes a switching element (not shown). The drive circuit 30R causes a squib (not shown) of the right front seat side-airbag 40R to generate heat. The heated squib ignites an inflator (not shown). With an expansion pressure of the ignited inflator, the right front seat side-airbag 40R is inflated into the vehicle compartment. The operations of the drive circuits 31R to 33R and 30L to 33L are the same as the above operation of the drive circuit 30R and therefore explanations thereof are here omitted.

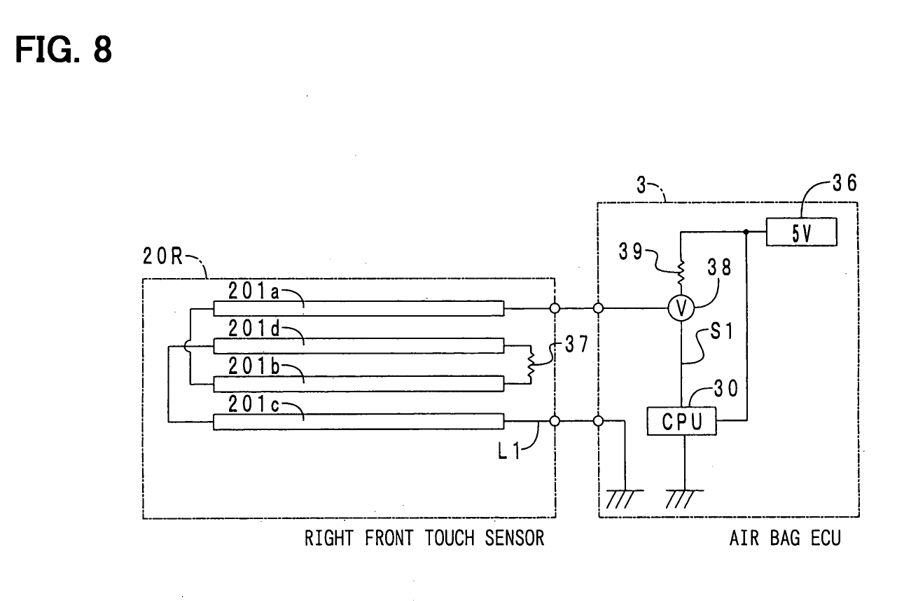

Next, a description will be given about a circuit configuration of a touch-sensor used in the airbag system of this embodiment. FIG. 8 is a circuit diagram of the right front seat touch-sensor in the airbag system of this embodiment. As shown in the same figure, the electrode wires 201a to 201d of the right front seat touch-sensor 20R are connected in series to a 5V power supply 36 of the airbag ECU 3. A resistor 39, a voltage detector 38 and a resistor 37 are also connected to the 5V power supply 36.

The 5V power supply 36, resistor 39, voltage detector 38, electrode wires 201a to 201d and resistor 37 are connected in the order of 5V power supply 36, resistor 39, voltage detector 38, electrode wire 201a, electrode wire 201b, resistor 37, electrode wire 201d and electrode wire 201c from high to low potential side, constituting a power line L1. That is, the electrode wires 201a and 201d which are adjacent to each other in the transverse direction as in FIG. 6 are connected together through the resistor 37. Likewise, the electrode wires 201b and 201c adjacent to each other in the transverse direction are connected together through the resistor 37. The voltage detector 38 is connected to the CPU 30 via a signal line S1.

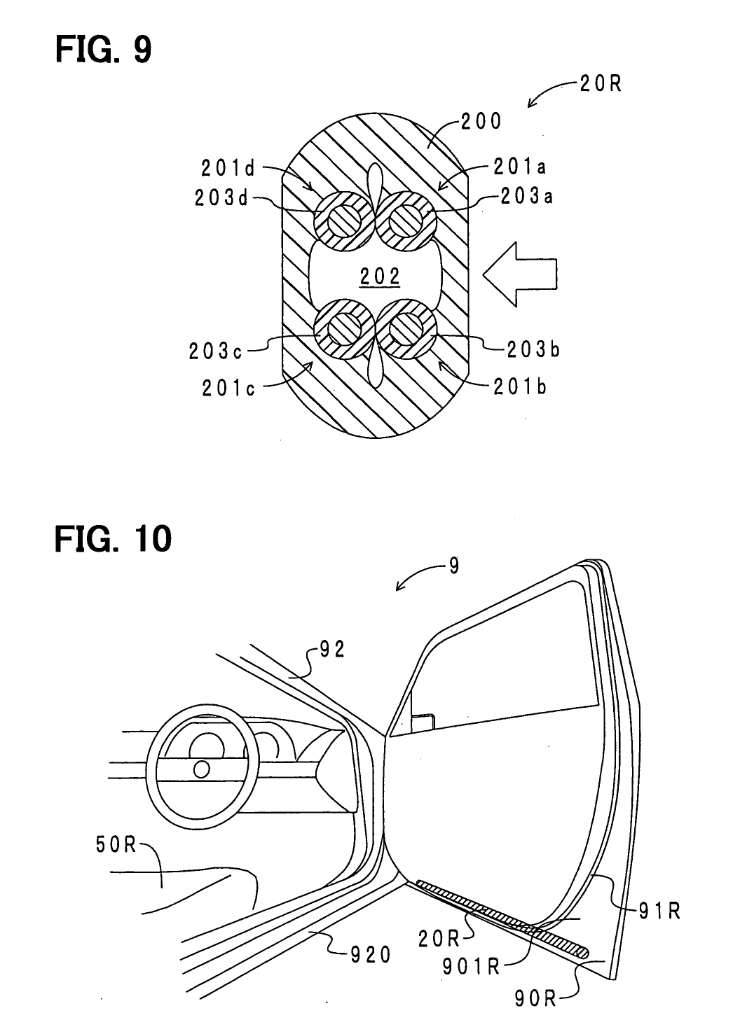

Next, a description will be given about the operation of the airbag system of this embodiment in the event of a side crash. FIG. 9 is a sectional view in a direction perpendicular to the axis of the right front seat touch-sensor in the event of a side crash of the airbag system of this embodiment. FIG. 9 is in a corresponding relation to FIG. 6.

As shown in FIG. 9, upon crash of another vehicle against the right front seat door 90R, the right front seat touch-sensor 20R is crushed in the transverse direction. As a result, the electrode wires 201a and 201d come into contact with each other. The electrode wires 201b and 201c also come into contact with each other. As described above, the electrode wires 201a and 201b are connected to the high potential side of the resistor 37 and the electrode wires 201c and 201d are connected to the low potential side of the resistor 37. Therefore, in the power line L1, the high potential side and the low potential side of the resistor 37 are shorted, with a consequent drop in voltage of the voltage detector 38. This voltage drop is transmitted as ON signal to the CPU 30 via the signal line S1.

In addition to the ON signal provided from the CPU 30, an acceleration waveform provided from the G-sensor 34 is also transmitted to the voltage detector 38. The CPU 30 performs an interval integration of the acceleration waveform to calculate a moving average value and compares the moving average value with a crash discriminating threshold value stored in the ROM of the CPU 30.

Upon input of the ON signal from the voltage detector 38 to the CPU 30 and when the moving average value of the acceleration waveform provided from the G-sensor 34 exceeds the crash discriminating threshold value, drive signals are provided from the CPU 30 to the drive circuits 30R and 32R. Upon receipt of the drive signals, the drive circuit 30R causes the right front seat side-airbag 40R to inflate into the vehicle compartment and the drive circuit 32R causes the right front seat curtain-airbag 42R to inflate into the vehicle compartment.

Operations performed upon exertion of a shock on the right rear seat touch-sensor 21R, left front seat touch-sensor 20L and left rear seat touch-sensor 21L are also the same as in case of a shock being exerted on the right front seat touch-sensor 20R and therefore explanations thereof are here omitted.

The right front seat touch-sensor 20R, right rear seat touch-sensor 21R, left front seat touch-sensor 20L and left rear seat touch-sensor 21L also serve as pinching G-sensors in the associated doors. More particularly, as shown in FIG. 3, if a foreign matter is pinched between the opening weather strip 91R and the side-sill 920 at the time of closing the right front seat door 90R, the right front seat touch-sensor 20R is deformed as shown in FIG. 9. Consequently, in the power line L1, the high potential side and the low potential side of the resistor 37 are shorted as shown in FIG. 8. As a result, the voltage flowing in the voltage detector 38 drops. This voltage drop is transmitted as ON signal to the CPU 30 via the signal line S1. Then, in accordance with a command provided from the CPU 30, a door warning lamp (not shown) installed within a meter cluster goes on.

Thus, as to the operations of the touch-sensors themselves (the right front seat touch-sensor 20R, right rear seat touch-sensor 21R, left front seat touch-sensor 20L and left rear seat touch-sensor 21L) there is no difference between the case where the touch-sensors are used for the detection of a side crash and the case where they are used for the detection of pinching of a foreign matter. When all of the doors of a vehicle 9 are closed, signals provided from the touch-sensors are processed as signals for the detection of a side crash. On the other hand, when at least one of the doors is open, signals provided from the touch-sensors are processed as signals for the detecting of pinching. Thus, according to opening or closure of the doors, the CPU 30 switches from one to the other between signals for the detection of a side crash and signals for the detection of pinching with respect to signals provided from the touch-sensors.

Next, with reference to FIG. 8, a description will be given about the operation in self-diagnosis of the airbag system of this embodiment. In self-diagnosis, a voltage is inputted to the CPU 30 from the voltage detector 38. When the inputted voltage rises, the CPU 30 determines that the power line L1 is disconnected.

When the transmission time of the voltage provided from the voltage detector 38 is much longer than that of the transmission time required in the event of occurrence of a crash, the CPU 30 determines that the power line L1 is shorted. In these cases, an airbag warning lamp (not shown) installed within the meter cluster goes on in accordance with a command provided from the CPU 30. In this embodiment, the power line L1 and the signal line S1 correspond to the diagnostic circuit in the present invention. The self-diagnosis is repeated at every predetermined time.

The self-diagnosis of the right rear seat touch-sensor 21R, left front seat touch-sensor 20L and left rear seat touch-sensor 21L is also performed in the same manner as in the above self-diagnosis of the right front seat touch-sensor 20R and therefore an explanation thereof is here omitted.

The following description is now provided about the function and effect of the airbag system of this embodiment. The touch-sensors used in the airbag system 1 of this embodiment each have a string-like appearance. The electrode wires 201a to 201d installed within each touch-sensor are arranged throughout the whole in the longitudinal direction of the touch-sensor. Therefore, each touch-sensor can detect pressure throughout the whole in the longitudinal direction which pressure is exerted on the vehicle 9 from the exterior of the vehicle. The touch-sensors are extended in the longitudinal direction of the vehicle 9 respectively in the right front seat door 90R, right rear seat door, left front seat door and left rear seat door. Therefore, according to the airbag system 1 of this embodiment it is possible to detect pressure over a wide longitudinal range of side portions of the vehicle 9.

Moreover, in the airbag system 1 of this embodiment there are used not G-sensors capable of being arranged only “dotwise” but touch-sensors capable of being arranged “linearly (or bandlike).” Therefore, the shock transfer path from a shocked position up to each touch-sensor can be made short or zero. Consequently, it is possible to suppress a lowering of the shock detecting accuracy.

Besides, since the shock transfer path is short, the shock absorbability of the members (outer panel 900R and inner panel 901R) which constitute the shock transfer member need not be taken into account. Therefore, the mounting cost of the airbag system 1 can be decreased. Moreover, the degree of freedom of the touch-sensor installing place becomes higher.

Such a complicated calculation as that performed for the acceleration waveform is not needed for ON or OFF signal provided from each touch-sensor. Consequently, it is possible to shorten the response time after the receipt of a shock until start-up of the airbags (right front seat side-airbag 40R, right rear seat side-airbag 41R, right front seat curtain-airbag 42R, right rear seat curtain-airbag 43R, left front seat side-airbag 40L, left rear seat side-airbag 41L, left front seat curtain-airbag 42L, and left rear seat curtain-airbag 43L).

Each touch-sensor in the airbag system 1 of this embodiment is disposed within the opening weather strip (91R). That is, each touch-sensor is disposed near an outer edge in the transverse direction of the vehicle 9. Therefore, a shock from a side portion of the vehicle 9 can be detected rapidly. Consequently, the response time after the receipt of a shock in a side portion of the vehicle 9 until start-up of each airbag can be further shortened.

Since each touch-sensor is disposed within the opening weather strip, the touch-sensor is easy to receive pressure, so that the shock detecting accuracy is improved. Besides, the mounting of each touch-sensor can be completed simultaneously with the mounting of the opening weather strip to the corresponding door. Thus, the mounting of each touch-sensor is easy.

Despite the touch-sensors are respectively disposed outside the doors (the right front seat door 90R, right rear seat door, left front seat door, and left rear seat door), they are invisible from the exterior of the vehicle 9. Therefore, according to the airbag system 1 of this embodiment it is possible to ensure not only a high shock detecting accuracy but also even a high design characteristic.

The touch-sensors also serve as pinching G-sensors. Therefore, in comparison with the case where pinching G-sensors and side shock touch-sensors are arranged separately, a number of parts can be reduced and the sensor installing space can be made compact.

Moreover, according to the airbag system 1 of this embodiment, disconnection and shorting of each touch-sensor can be detected by self-diagnosis of the airbag ECU 3. Besides, disconnection and shorting of each touch-sensor are displayed on the meter cluster. Thus, an occupant or a worker can detect disconnection of a touch-sensor quickly.

A side-sill is disposed inside each touch-sensor in the vehicular transverse direction (see FIG. 5). The rigidity of the side-sill is high in comparison with the rigidity of the doors. Consequently, in the event of a side crash, each touch-sensor is compressed between a door easy to be crushed and a side-sill difficult to be crushed. Thus, according to the airbag system 1 of this embodiment it is possible to further shorten the response time after the receipt of a shock in a side portion of the vehicle 9 until start-up of each airbag.

### Second Embodiment

An airbag system of this second embodiment is different from the airbag system of the first embodiment in that each touch-sensor is disposed in the interior of each door. Therefore, only the different point will be described below.

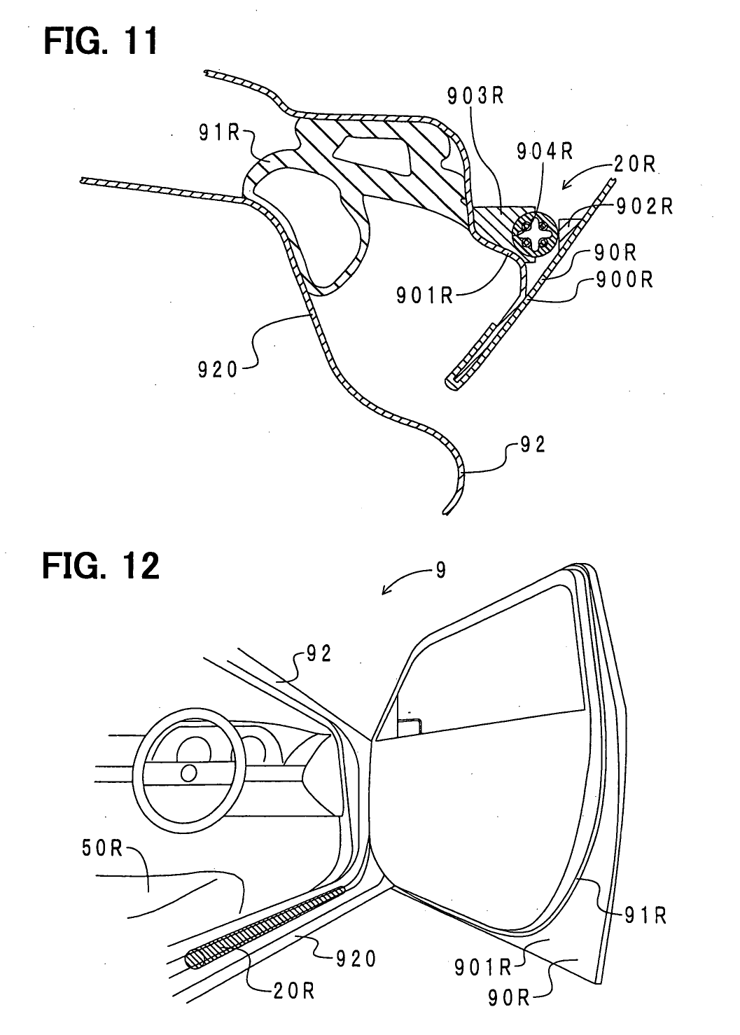

FIG. 10 is a perspective view of a right front seat and the vicinity thereof in a vehicle in which the airbag system of this embodiment is disposed. In FIG. 10, the portions corresponding to those in FIG. 3 are identified by the same reference numerals as in FIG. 3. FIG. 11 is a sectional view of a lower edge of a right front seat door and the vicinity thereof in the same vehicle. In FIG. 11, the portions corresponding to FIG. 5 are identified by the same reference numerals as in FIG. 5.

As shown in the figures, a rib-like mounting member 903R is projected from an inner surface (right surface) of an inner panel 901R. A right end face 904R of the mounting member 903R has a recessed section. A right front seat touch-sensor 20R is accommodated within the right end face 904R.

On the other hand, a rib-like pressing member 902R is projected from an inner surface (left surface) of an outer panel 900R. A left end face of the pressing member 902R is disposed on the right side of the right front seat touch-sensor 20R spacedly only a slight distance.

In the event of crash of another vehicle against the right front seat door 90R, the pressing member 902R pushes the right front seat touch-sensor 20R to the left side. However, the right front seat touch-sensor 20R is held from the left side by the mounting member 903R. As a result, the right front seat touch-sensor 20R is deformed like being crushed between the pressing member 902R and the mounting member 903R.

The layout and operations of the right rear seat touch-sensor 21R, the left front seat touch-sensor 20L and the left rear seat touch-sensor 21L are the same as those described above of the right front seat touch-sensor 20R and therefore explanations thereof are here omitted.

The airbag system of this embodiment has the same function and effect as that of the airbag system of the first embodiment. In the airbag system of this embodiment, each touch-sensor is accommodated in the interior of each door. Therefore, each touch-sensor can be protected from a light shock and hence it is possible to prevent a malfunction of each touch-sensor.

Each touch-sensor is interposed between the mounting member 903R and the pressing rib (902R) substantially closely without a gap. Therefore, according to the airbag system of this embodiment, the response time until start-up of each airbag after the receipt of a shock in a vehicular side portion can be further shortened.

In the airbag system of this embodiment, moreover, the length in the vehicular longitudinal direction of each touch-sensor is not restricted by the length in the same direction of the opening weather strip 91R. Therefore, each touch-sensor can be disposed beyond the overall length in the longitudinal direction of the opening weather strip 91R and substantially throughout the overall length in the longitudinal direction of each door. Consequently, according to the airbag system of this embodiment, the shock detection range in the vehicular longitudinal direction becomes still wider.

### Third Embodiment

This third embodiment is different from the first embodiment in that each touch-sensor is disposed in the interior of each side-sill. Therefore, only the different point will be described below.

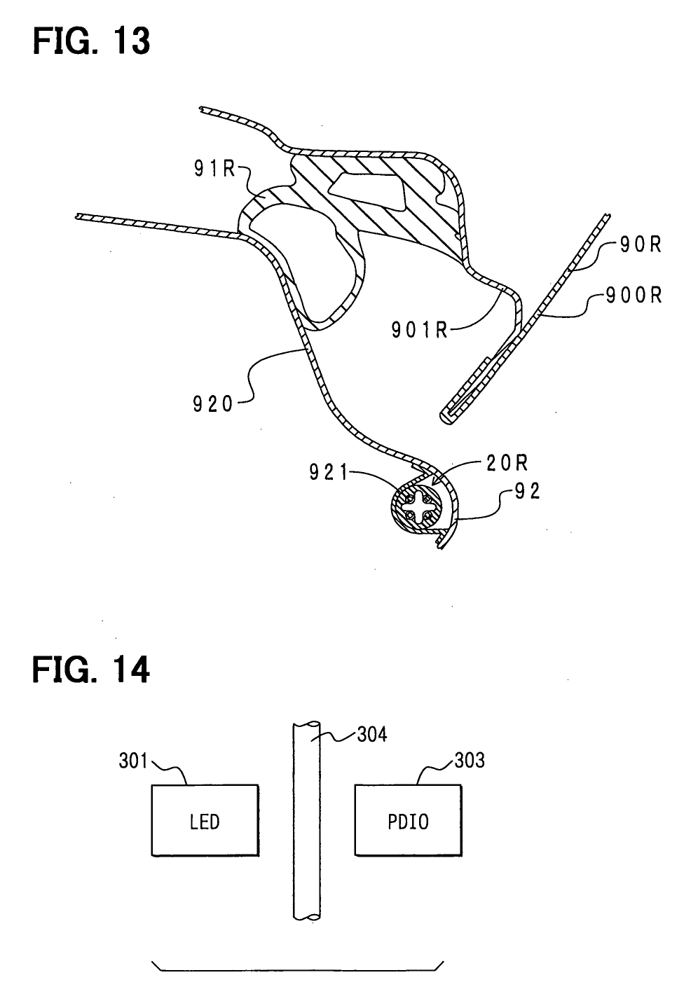

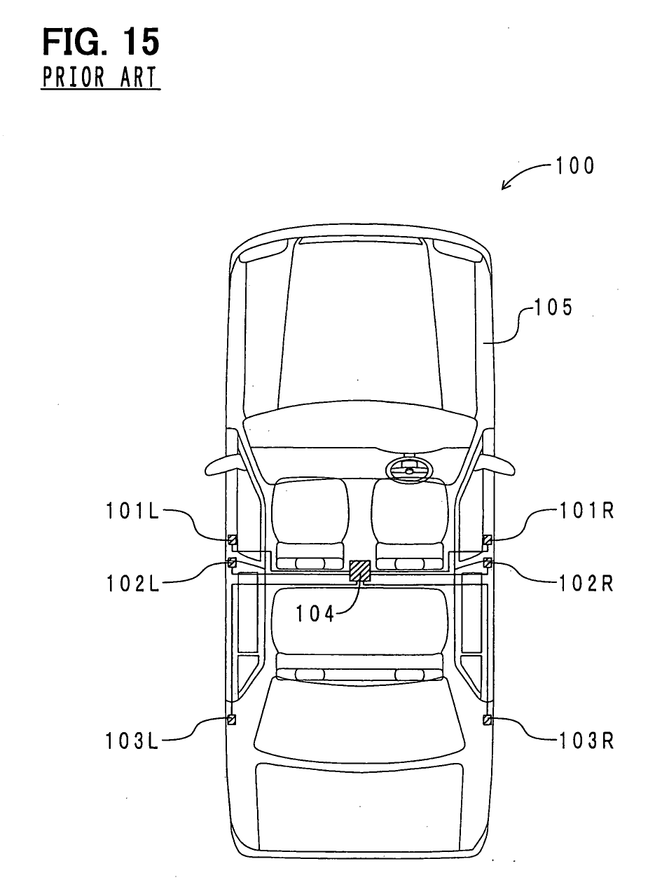

FIG. 12 is a perspective view of a right front seat and the vicinity thereof in a vehicle in which an airbag system of this embodiment is disposed. In FIG. 12, the portions corresponding to those in FIG. 3 are identified by the same reference numerals as in FIG. 3. FIG. 13 is a sectional view of a lower edge of a right front seat door and the vicinity thereof in the vehicle. In FIG. 13, the same portions as in FIG. 5 are identified by the same reference numerals as in FIG. 5.

As shown in these figures, an elongated semicylindrical holder 921 is attached to an inner surface (left surface) of a side-sill 920. A right front seat touch-sensor 20R is disposed in the interior of the holder 921.

The airbag system of this embodiment has the same function and effect as that of the airbag system of the first embodiment. In the airbag system of this embodiment, a right front seat door 90R is not disposed on the right side of the right front seat touch-sensor 20R. Therefore, according to the airbag system of this embodiment, the response time until start-up of each airbag after the receipt of a shock in a vehicle side portion can be further shortened.

In the airbag system of this embodiment, the right front seat touch-sensor 20R is not disposed in the right front seat door 90R. Therefore, there is little fear of malfunction of the right front seat touch-sensor 20R upon opening or closing of the right front seat door 90R.

### Others

Embodiments of the occupant protecting system of the present invention have been described above. However, no limitation is made to the above embodiments, but various changes and modifications capable of being carried out by those skilled in the art may be made.

For example, in the airbag systems of the above embodiments, the power line L1 of the electrode wires 201a to 201d are connected to the 5V power supply 36, as shown in FIG. 8. However, the power line L1 may be connected to the vehicular battery.

Although in the above embodiments a crash is determined using an ON signal provided from each touch-sensor and an acceleration waveform provided from the G-sensor 34, the same determination may be done using the ON signal alone provided from each touch-sensor. In this case, the determination of a crash may be done on the basis of a duration time of the ON signal provided from each touch-sensor. More particularly, a duration time threshold value is stored beforehand in the ROM of the CPU 30 and the airbags may be started to operate when the transmission of ON signal is continued beyond the duration time threshold value. By so doing, the calculation load of the CPU 30 is further lightened, so that the response time until start-up of each airbag after the receipt of a shock in a vehicular side portion can be further shortened.

Although in the above embodiments touch-sensors are used as pressure sensors in the present invention, optical fiber sensors may be used. More particularly, as shown in FIG. 14, LED 301 and photodiode 303 may be used as a light emitting element and a light receiving element, respectively, and an optical fiber 304 may be disposed between the two. In the event of a vehicular crash, the optical fiber 304 is deformed like being crushed. Further, a detected signal (e.g., electric current) provided from the photodiode 303 changes depending on the degree of crush of the optical fiber 304. Therefore, the crash can be detected on the basis of the detected signal provided from the photodiode 303.

The detected signal from the photodiode 303 changes in multiples steps depending on the degree of crush of the optical fiber 304. Thus, the start pattern of the occupant protecting means such as airbags can be switched from one to another according to the degree of a crash. For example, switching can be done such that the gas pressure in each airbag is made low in the event of a light crash, while it is made high in the event of a heavy crash. In this case, a semiconductor laser may be used as the light emitting element and a phototransistor may be used as the light receiving element.

The place where each touch-sensor is to be disposed is not specially limited. For example, each touch-sensor may be disposed within a side lace, whereby each touch-sensor further approaches an outer edge in the vehicular transverse direction. Consequently, the response time until start-up of each airbag after the receipt of a shock in a vehicular side portion can be further shortened. Further, each touch-sensor may be disposed outside a vehicular door and may be covered with a case to prevent the occurrence of malfunction.

Although in the above embodiments there are used touch-sensors for detecting a side crash, a touch-sensor may be used for detecting a front crash. In this case, a transversely extending touch-sensor may be accommodated in the interior of a bumper for example. Two touch-sensors may be disposed on the right and left sides, respectively, of the bumper. In this case, airbags located in front the right and left front seats, respectively, may be operated by the airbag ECU 3. Although in each of the above embodiments the airbags are operated as occupant protecting means, for example a seat belt pretensioner may be operated.

What is claimed is:

1. An occupant protecting system comprising:
an elongated pressure sensor, at least a part of the pressure sensor being extended in at least one of a longitudinal direction of a vehicle in a side portion of the vehicle and a transverse direction of the vehicle in a front portion of the vehicle, the pressure sensor being able to detect a pressure substantially throughout the whole in a longitudinal direction of the vehicle which pressure is exerted on the vehicle from an exterior of the vehicle; and
an electric control unit which drives occupant protecting means upon receipt of a detected signal from the pressure sensor.

2. An occupant protecting system according to claim 1, wherein the pressure sensor is disposed on a side door of the vehicle.

3. An occupant protecting system according to claim 2, wherein the pressure sensor is disposed in an interior of a door.

4. An occupant protecting system according to claim 2, wherein the door has an opening weather strip for filling up a gap between the door and a body of the vehicle when the door is closed, and
the pressure sensor is disposed in an interior of the opening weather strip.

5. An occupant protecting system according to claim 2, wherein the pressure sensor is disposed at a position opposed to a side-sill of a body of the vehicle in a transverse direction of the vehicle.

6. An occupant protecting system according to claim 1, wherein the pressure sensor is disposed in a body of the vehicle.

7. An occupant protecting system according to claim 6, wherein the pressure sensor is disposed in an interior of a side-sill of the vehicle body.

8. An occupant protecting system according to claim 1, wherein the pressure sensor also serves as a pinching G-sensor for detecting pinching when the door is closed.

9. An occupant protecting system according to claim 1, wherein the pressure sensor is a touch-sensor comprising a tubular skin portion and a plurality of electrode portions disposed in an interior of the skin portion, at least two of the plural electrode portions coming into contact with each other upon deformation of the skin portion in order to detect a pressure exerted on the vehicle from the exterior of the vehicle.

10. An occupant protecting system according to claim 1, wherein the pressure sensor comprises a light emitting element, an optical fiber through which light emitted from the light emitting element passes, and a light receiving element for receiving the light having passed through the optical fiber, the optical fiber being adapted to be deformed, causing a change in loss of the light that the light receiving element receives in order to detect a pressure exerted on the vehicle from the exterior of the vehicle.

11. An occupant protecting system according to claim 1, wherein the electric control unit has a diagnostic circuit capable of trouble-shooting the pressure sensor.

12. An occupant protecting system according to claim 1, wherein the occupant protecting means is at least one of a side-airbag and a curtain-airbag.
